(19) United States
(12) Patent Application Publication
(10) Pub. No.: US 2016/0058045 A1
(43) Pub. Date: Mar. 3, 2016

(54) Method of Loading Flavor into an Aerogel and Flavor Impregnated Aerogel Based on Food Grade Materials

(71) Applicant: PepsiCo, Inc., Purchase, NY (US)

(72) Inventors: Cuie Yan, Chappaqua, NY (US); Peter S. Given, JR., Stowe, VT (US); Gary Huvard, Chesterfield, VA (US); Rajendar Reddy Mallepally, Henrico, VA (US); Mark A. McHugh, Richmond, VA (US)

(21) Appl. No.: 14/469,197

(22) Filed: Aug. 26, 2014

(51) Int. Cl. A23L 1/22; A23L 1/0532; A23L 1/0524; A23L 1/0562; A23L 1/0522

(52) U.S. Cl. CPC A23L 1/22008; A23L 1/0562; A23L 1/0522; A23L 1/0524; A23L 1/0532; A23V 2002/00

(57) ABSTRACT

Food grade aerogels are used for the impregnation of flavor with the help of supercritical carbon dioxide technology. One or more food grade materials are used for the formation of a food grade aerogel. Supercritical carbon dioxide technology is used both for formation of the aerogel and for impregnating of the formed aerogel with a flavor. Resulting food grade aerogels possess a high flavor loading capacity of up to about 70%, which is well above the average loading capacity of the most common flavor encapsulation technology via spray drying (which are about 20% capacity loading), while maintain the integrity of flavors, particularly top notes.

### BACKGROUND OF THE INVENTION

1. Technical Field

The present invention relates to a method of preparing food grade aerogels, and a method for the loading of flavor into a prepared food grade aerogel, in which the flavor is loaded, and the resulting food grade aerogel.

2. Description of Related Art

Flavors are important in any food formula and can influence the finished product quality and cost. It is important to harness flavors and aromas to make products appealing to consumers for as long as possible after the product is initially produced. However, the complex systems associated with flavors are often difficult and expensive to control, because one flavor may contain thousands of flavor compounds, and most of the flavor compounds are delicate and volatile, particularly top notes. They escape and are oxidized quickly and easily at or below room temperature in the atmosphere. Thus, their retention and integrity are big concerns for food manufacturers.

To prevent a product from losing its desired flavor attributes, it is beneficial to encapsulate flavor prior to use in foods or beverages. Encapsulation of flavors has been attempted and commercialized using many different methods and different forms of physical entrapment of flavors. Spray drying is a commercial encapsulation process often used in the food and pharmaceutical industries. The process involves the dispersion of the substance to be encapsulated in a carrier material, which is typically a modified starch or gum Arabic, as a suspension in water to form a slurry. The slurry is then fed into a hot chamber, where it is atomized to form small droplets and dried to a powder. This technology produces a very fine powder that typically requires further processing and does not produce uniform encapsulations. In addition, spray drying processes limit the choice of wall materials and fail to retain highly volatile flavor components. Thus, heat sensitive materials, such as those in flavors, are not ideal for encapsulation using spray drying. Extrusion is another encapsulation process commonly used but this process is sensitive to any structural defects formed during or after processing. This limits shelf life due to slow diffusion and oxidation of encapsulated flavors. There is a need for delivery systems that protect flavor compounds well and provide high loading levels of flavors.

### SUMMARY OF THE INVENTION

The present invention pertains to the formation of food grade aerogels from one or more food grade materials; and the impregnation of flavors onto the aerogels assisted by supercritical carbon dioxide technology. After selecting a suitable food grade material, a food grade hydrogel is formed, followed by aerogel formation through an alcogel. Then flavor is impregnated onto the aerogel assisted by supercritical carbon dioxide. The flavor loaded food grade aerogel releases flavors loaded therein under certain triggers, such as pH, ion strength, moisture, temperature, or mechanic force. Aerogel formation is performed with a series of suspensions in gradually increasing ethanol concentrations before overnight suspension in 100% ethanol solution. Supercritical carbon dioxide technology is used for both formation of the aerogel and for impregnating of the formed aerogel with a flavor. Resulting food grade aerogels possess a high flavor loading capacity of up to about 70%, which is well above the average loading capacity of the most common flavor encapsulation technology via spray drying (which are up to 20% capacity loading), while maintain the integrity of flavors, particularly top notes. Other advantages and benefits will be set forth in part in the description below. The advantages described below will be realized and attained by means of the elements and combinations particularly pointed out in the appended claims.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1a is a scanning electron microscopy image of an alginate aerogel prepared for flavor loading as described herein.

FIG. 1b is a scanning electron microscopy image of a starch aerogel prepared for flavor loading as described herein.

FIG. 1c is a scanning electron microscopy image of a pectin aerogel prepared for flavor loading as described herein.

FIG. 2 depicts a sample drawing of equipment used to perform flavor loading steps as described herein.

FIGS. 3a and 3b are thermogravimetril analysis of limonene flavor retention of three different polysaccharide aerogels prepared by the methods described herein.

FIGS. 4a and 4b are graphical representations displaying thermogravimetric analysis of SiO₂ aerogel loaded with limonene.

FIG. 5 is a graphical representation demonstrating the shelf-life of a limonene loaded SiO₂ aerogel.

### DETAILED DESCRIPTION

Aerogels are formed by removing liquid from a gel, for example, evaporating water from a hydrogel. Aerogels are porous and lightweight materials, with high porosity, low density, and a large surface area. Typically, aerogels are formed from inorganic compounds such as silica. More recently, the concept of polysaccharides from plants, alga and crustaceans as aerogel-forming materials has emerged. However, to date, food applications of food grade aerogels do not exist. The present disclosure sets forth a method of applying food grade aerogels from a number of sources, including those not yet considered, to the realm of flavor loading and encapsulations.

A first aspect of the present disclosure thus relates generally to a method of embedding flavors within highly porous food grade aerogels through a sub or super critical carbon dioxide assisted process. The method comprises the steps of selecting a food grade material for preparation of a porous food grade aerogel, wherein said food grade material is a non-silica organic material and wherein the food grade aerogel provides for release of a flavor loaded therein; preparing the food grade aerogel using a supercritical carbon dioxide assisted process; and impregnating the food grade aerogel with flavor using a supercritical carbon dioxide assisted process, thereby forming a flavor loaded food grade aerogel, from which loaded flavors can ultimately be released. The food grade aerogel disclosed herein may be prepared from a good grade material selected from a polysaccharide, protein, solid lipid, or a combination thereof. Resulting aerogels are not only stable, similar to inorganic aerogels, but also safe to ingest. Using the method described herein an aerogel is successfully loaded with flavor, and the resulting flavors are able to retain both their nonvolatile and volatile components at very high loading levels while maintaining their integrity until the release is desired. Encapsulation is the technique by which one material or a mixture of materials (known as active or core material) is coated with or entrapped within another material or system (referred to as shell, wall material, matrix, carrier or encapsulant). In one embodiment, the flavor may be entrapped within the aerogel porous structure. In one embodiment, the flavor may be coated on the interface of the food grade aerogel porous structure. The actual entrapment mechanism will depend in part on the resulting pore size of the food grade aerogel, the material selected for creating the aerogel, and/or the nature of the flavor compounds.

### Selecting a Food Grade Material

It is preferable to select a food grade material that is not only safe to ingest but also one that provides controlled release of embedded flavors in different food applications under certain triggers. More specifically, the step of selecting a food grade material for preparing the porous food grade aerogel may comprise selection of one or more of: starch, pectin, alginate, cellulose, starch sodium octenyl succinate, locust bean gum, carrageenan, agar, xanthan gum, guar gum, chitosan, gelatin, casein, whey protein isolate, soy protein isolate, pea protein isolate, potato protein isolate, zein, lecithins, stearic acid, beeswax, cottonseed wax, carnauba wax, milk fat, palm and palm kernel oil, or any combination thereof. In one embodiment, the step of selecting a food grade material for preparing the porous food grade aerogel may comprise selection of two or more of: starch, pectin, alginate, cellulose, starch sodium octenyl succinate, carrageenan, agar, xanthan gum, guar gum, chitosan, gelatin, casein, whey protein isolate, soy protein isolate, pea protein isolate, potato protein isolate, zein, lecithins, stearic acid, beeswax, cottonseed wax, carnauba wax, milk fat, palm and palm kernel oil, or any combination thereof. In one embodiment, the step of selecting a food grade material for preparing the porous food grade aerogel may comprise selection of three or more of: starch, pectin, alginate, cellulose, starch sodium octenyl succinate, carrageenan, agar, xanthan gum, guar gum, chitosan, gelatin, casein, whey protein isolate, soy protein isolate, pea protein isolate, potato protein isolate, zein, lecithins, stearic acid, beeswax, cottonseed wax, carnauba wax, milk fat, palm and palm kernel oil, or any combination thereof.

Starch is a suitable food grade material for preparing the porous food grade aerogel described herein. Starch consists of two major components, amylose and amylopectin. Amylose is linearly comprise of α-(1→4)-linked D-glucopyranosyl units with an average molecular weight of 500 kg/mol. Amylose forms the amorphous part of starch, while amylopectin is the component of the crystalline parts. Amylopectin comprises a backbone of α-(1→4)-linked D-glucopyranosyl units, with branching taking place with α(1→6) bonds occurring every 24 to 30 glucose units. Suitable starch for preparation of the aerogels described herein can be obtained from any number of commercial sources.

Pectin is a suitable food grade material for preparing the porous food grade aerogel described herein. Pectin is a grouping of acid structural polysaccharides found in fruit and vegetables and is prepared mainly from citrus peel waste and apple pomace. Suitable pectin for preparation of the aerogels described herein can be obtained from any number of commercial sources.

Alginate is a suitable food grade material for preparing the porous food grade aerogel described herein. Alginate, also known as alginic acid sodium salt, is a natural anionic polysaccharide mainly derived from brown algae. It is a linear random copolymer of (1,4′)-linked β-D-mannuronic acid and α-L-guluronic acid monomers with the chemical structure. Alginates are natural polyelectrolytes that form hydrogels at low concentrations (1-2%). Gelling of alginates occurs when di or trivalent cations participate in the interchain binding between sequences of mannuronic and guluronic acid residues. The di or trications form a cross-link between two carboxylic groups, resulting in a three-dimensional network. Suitable alginate for preparation of the aerogel described herein can be readily obtained from any number of commercial sources.

Cellulose is a suitable food grade material for preparing the porous food grade aerogel described herein. Cellulose is an organic polysaccharide having a linear structure comprise of β-(1→4) linked D-glucopyranosyl units. It is an important structural component of the cell wall of green plants and many forms of algae. It is the most abundant polysaccharide on earth and suitable sources for the preparation of the aerogel described herein is readily available from any number of commercial sources.

Starch sodium octenyl succinate is a suitable food grade material for preparing the porous food grade aerogel described herein. Starch sodium octenyl succinate is a chemically modified starch that results during the reaction of starch with succinic acid and octanol. Suitable alginate for preparation of the aerogel described herein can be obtained from any number of commercial sources.

Locust bean gum is a suitable food grade material for preparing the porous food grade aerogel described herein and can be found from any number of commercial sources.

Carrageenan is a suitable food grade material for preparing the porous food grade aerogel described herein. Carrageenans or carrageenins are a family of linear sulphated polysaccharides that are extracted from red edible seaweeds. Carrogeenan is another algae-derived polysaccharide that shows gelling capacity induced by cations. Suitable carrageenans for preparation of the aerogel described herein can be obtained from any number of commercial sources.

Agar is a suitable food grade material for preparing the porous food grade aerogel described herein. Agar is a polymer made up of subunits of galactose and is a component of algae cell walls. Suitable agar for preparation of the aerogel described herein can be obtained from commercial sources such as AGAR RS-100™ from TIC Gums (Belcamp, Md.).

Xanthum gum is a suitable food grade material for preparing the porous food grade aerogel described herein. Xanthum gum is a natural gum polysaccharide used as a food additive and rheology modifier. It is produced by a biotechnological process involving fermentation of glucose or sucrose by Xanthomonas campestris. It is capable of producing a large increase in viscosity by adding a very small quantity of burn, on the order of one percent. In most foods, it is used at a percentage of about 0.5%, or as low as 0.05%. Xantham gum is very stable under a wide range of temperatures and pH and is readily available from any number of commercial sources.

Guar gum is a suitable food grade material for preparing the porous food grade aerogel described herein. Guar gum is a galactomannan, which are polysaccharides consisting of a mannose backbone with galactose side groups ((1-4)-linked β-D-mannopyranose backbone with branchpoints from their 6-positions linked to α-D-galactose, i.e. 1-6-linked α-D-galactopyranose). Galactomannans are commonly used in foods as stabilizers and guar gum may be used in ice cream to reduce melting. Suitable guar gum for preparing the aerogel described herein may be found at any number of commercial sources.

Chitosan is a suitable food grade material for preparing the porous food grade aerogel described herein. Chitosan is a linear polysaccharide composed of randomly distributed β-(1-4)-linked D-glucosamine (deacetylated unit) and N-acetyl-D-glucosamine (acetylated unit). It is made by treating shrimp and other crustacean shells with the alkali sodium hydroxide.

Gelatin is a suitable food grade material for preparing the porous food grade aerogel described herein. Gelatin is an irreversibly hydrolyzed form of collagen often derived from the bones, skin, and cartilage of fish, swing, and/or cattle. It is commonly used as a gelling agent in foods and may be obtained from any number of commercial sources.

Casein is a suitable food grade material for preparing the porous food grade aerogel described herein and can be found from any number of commercial sources.

Whey protein isolate (WPI) is a suitable food grade material for preparing the porous food grade aerogel described herein. WPI comes from whey protein and container greater than 90% protein. As used herein, WPI specifically excludes whey protein concentrate. Because whey protein concentrate comprises a lower protein content, use of whey protein concentrate would result in a pore size too large to be referred to as an aerogel. WPI is a collection of globular proteins that is isolated from whey, a by-product of cheese manufactured from bovine milk. It is a mixture of β-lactoglobulin (about 65%), α-lactoglobulin (about 25%), and serum albumin (about 8%), which are soluble in their native forms, independent of pH. WPI can be commercially obtained from sources such as NZMP ALACEN 895™ from Nealanders International Inc. (Rocky River, Ohio), or WPI BiPro with a protein content of 94% w/w from Davisco Foods.

Soy protein isolate (SPI) is a suitable food grade material for preparing the porous food grade aerogel described herein. SPI is a highly refined or purified form of soy protein with a minimum protein content of about 90% on a dry basis. It is made from defatted soy flour, which has had most of the non-protein components, fats and carbohydrates removed. It can be obtained from commercial sources such as PRO FAM781™ from ADM Protein Specialties Division (Decatur, Ill.). As used herein, SPI specifically excludes soy protein concentrate. Again, soy protein concentration would not result in aerogel formation.

Pea protein isolate (PPI) is a suitable food grade material for preparing the porous food grade aerogel described herein. It is a natural vegetable protein and provides a number of nutritional benefits. PPI can be obtained from any variety of species of pea and is specifically meant to be exclusive of pea protein concentrate. As used herein, pea protein isolate specifically excludes pea protein concentrate, which is not suitable for formation of an aerogel due to its low protein concentration.

Potato protein isolate (PoPI) is a suitable food grade material for preparing the porous food grade aerogel described herein. Potato protein isolate can be obtained from any variety of potatoes and is specifically meant to exclude pea protein concentrate. PoPI, as used herein, is specifically meant to exclude potato protein concentrate, which is not suitable for formation of an aerogel due to its low protein concentration.

Zein is a suitable food grade material for preparing the porous food grade aerogel described herein. Zein is an insoluble cereal prolamine proteins. It is clear, odorless, tasteless, hard, water-insoluble and edible. Zein provides an excellent water barrier, offering extended shelf-life, particularly under high-humidity, and high heat conditions. In combination with the method disclosed herein, zein provides for flavor encapsulations with very high flavor load concentration and retention not yet seen in the art. Commercially available zein can be obtained from any number of sources.

Lecithin is a suitable food grade material for preparing the porous food grade aerogel described herein. It is an all-natural emulsifier derived from product such as soy, eggs, sunflower and canola seeds. Lecithins are readily commercial available from a number of sources.

Stearic acid is a suitable food grade material for preparing the porous food grade aerogel described herein. It is a saturated fatty acid that occurs in many animal and vegetable fats and oils.

Beeswax is a suitable food grade material for preparing the porous food grade aerogel described herein. Beeswax is a natural wax produced in the bee hive of honey bees of the genus Apis. Cottonseed wax is a suitable food grade material for preparing the porous food grade aerogel described herein. Cottonseed wax is a wax made from hydrogenated cottonseed oil. Carnauba wax is a suitable food grade material for preparing the porous food grade aerogel described herein. It is a wax from the leaves of the carnauba palm Copernicia prunifera. These waxes are readily obtainable from any number of commercial sources.

Further suitable food grade materials are milk fat, palm oil and palm kernel oils. Palm oil is an edible vegetable oil derived from the mesocarp of the fruit of the oil palms. Palm kernel oil is an edible plant oil derived from the kernel of the oil palm. Both oils are readily obtainable from any number of commercial sources.

In one embodiment, the food grade material for preparation of the aerogel may comprise gelatin together with one or more of: pectin, alginate, cellulose, starch sodium octenyl succinate, locust bean gum, carrageenan, agar, xanthan gum, guar gum, chitosan, casein, whey protein isolate, soy protein isolate, pea protein isolate, potato protein isolate, zein, lecithins, stearic acid, beeswax, cottonseed wax, carnauba wax, milk fat, palm and palm kernel oil, or any combination thereof. In one embodiment, the food grade material for preparation of the aerogel may comprise pectin together with one or more of: starch, alginate, cellulose, starch sodium octenyl succinate, locust bean gum, carrageenan, agar, xanthan gum, guar gum, chitosan, gelatin, casein, whey protein isolate, soy protein isolate, pea protein isolate, potato protein isolate, zein, lecithins, stearic acid, beeswax, cottonseed wax, carnauba wax, milk fat, palm and palm kernel oil, or any combination thereof. In one embodiment, the food grade material for preparation of the aerogel may comprise alginate together with one or more of: starch, pectin, cellulose, starch sodium octenyl succinate, locust bean gum, carrageenan, agar, xanthan gum, guar gum, chitosan, gelatin, casein, whey protein isolate, soy protein isolate, pea protein isolate, potato protein isolate, zein, lecithins, stearic acid, beeswax, cottonseed wax, carnauba wax, milk fat, palm and palm kernel oil, or any combination thereof.

In one embodiment, the food grade material for preparation of the aerogel may comprise cellulose together with one or more of: starch, pectin, alginate, starch sodium octenyl succinate, locust bean gum, carrageenan, agar, xanthan gum, guar gum, chitosan, gelatin, casein, whey protein isolate, soy protein isolate, pea protein isolate, potato protein isolate, zein, lecithins, stearic acid, beeswax, cottonseed wax, carnauba wax, milk fat, palm and palm kernel oil, or any combination thereof.

In one embodiment, the food grade material for preparation of the aerogel may comprise cellulose together with chitosan, gelatin, and solid lipids. In one embodiment, the food grade material selected is a combination of cellulose and chitosan. In one embodiment, the food grade material selected is a combination of cellulose and gelatin. In one embodiment, the food grade material selected is a combination of alginate with gelatin. In one embodiment, the food grade material selected is a combination of alginate with chitosan.

In one embodiment, the food grade material for preparation of the aerogel may comprise whey protein isolate together with one or more of: starch, pectin, alginate, cellulose, starch sodium octenyl succinate, locust bean gum, carrageenan, agar, xanthan gum, guar gum, chitosan, gelatin, casein, soy protein isolate, pea protein isolate, potato protein isolate, zein, lecithins, stearic acid, beeswax, cottonseed wax, carnauba wax, milk fat, palm and palm kernel oil, or any combination thereof. In one embodiment, the food grade material for preparation of the aerogel may comprise soy protein isolate together with one or more of: starch, pectin, alginate, cellulose, starch sodium octenyl succinate, locust bean gum, carrageenan, agar, xanthan gum, guar gum, chitosan, gelatin, casein, whey protein isolate, pea protein isolate, potato protein isolate, zein, lecithins, stearic acid, beeswax, cottonseed wax, carnauba wax, milk fat, palm and palm kernel oil, or any combination thereof. In one embodiment, the food grade material for preparation of the aerogel may comprise pea protein isolate together with one or more of: starch, pectin, alginate, cellulose, starch sodium octenyl succinate, locust bean gum, carrageenan, agar, xanthan gum, guar gum, chitosan, gelatin, casein, whey protein isolate, soy protein isolate, potato protein isolate, zein, lecithins, stearic acid, beeswax, cottonseed wax, carnauba wax, milk fat, palm and palm kernel oil, or any combination thereof. In one embodiment, the food grade material for preparation of the aerogel may comprise potato protein isolate together with one or more of: starch, pectin, alginate, cellulose, starch sodium octenyl succinate, locust bean gum, carrageenan, agar, xanthan gum, guar gum, chitosan, gelatin, casein, whey protein isolate, soy protein isolate, pea protein isolate, zein, lecithins, stearic acid, beeswax, cottonseed wax, carnauba wax, milk fat, palm and palm kernel oil, or any combination thereof. In one embodiment, the food grade material for preparation of the aerogel may comprise zein together with one or more of: starch, pectin, alginate, cellulose, starch sodium octenyl succinate, locust bean gum, carrageenan, agar, xanthan gum, guar gum, chitosan, gelatin, casein, whey protein isolate, soy protein isolate, pea protein isolate, potato protein isolate, zein, lecithins, stearic acid, beeswax, cottonseed wax, carnauba wax, milk fat, palm and palm kernel oil, or any combination thereof.

In one embodiment, the food grade material for preparation of the aerogel may comprise whey protein isolate together with pectin. In one embodiment, the food grade material for preparation of the aerogel may comprise whey protein isolate together with alginate. In one embodiment, the food grade material for preparation of the aerogel may comprise whey protein isolate together with carrageenan. In one embodiment, the food grade material for preparation of the aerogel may comprise whey protein isolate together with one of: pectin, alginate, locust bean gum, or carrageenan and zein. In one embodiment, the food grade material for preparation of the aerogel may comprise whey protein isolate together with one of: pectin, alginate, locust bean gum or carrageenan; zein; and with one of: beeswax, cottonseed wax, or carnauba wax.

In one embodiment, the food grade material for preparation of the aerogel may comprise soy protein isolate together with pectin. In one embodiment, the food grade material for preparation of the aerogel may comprise soy protein isolate together with alginate. In one embodiment, the food grade material for preparation of the aerogel may comprise soy protein isolate together with carrageenan. In one embodiment, the food grade material for preparation of the aerogel may comprise soy protein isolate together with one of: pectin, alginate, locust bean gum or carrageenan and zein. In one embodiment, the food grade material for preparation of the aerogel may comprise soy protein isolate together with one of: pectin, alginate, locust bean gum or carrageenan; zein; and with one of: beeswax, cottonseed wax, or carnauba wax.

In one embodiment, the food grade material for preparation of the aerogel may comprise pea protein isolate together with pectin. In one embodiment, the food grade material for preparation of the aerogel may comprise pea protein isolate together with alginate. In one embodiment, the food grade material for preparation of the aerogel may comprise pea protein isolate together with carrageenan. In one embodiment, the food grade material for preparation of the aerogel may comprise pea protein isolate together with one of: pectin, alginate, locust bean gum or carrageenan and zein. In one embodiment, the food grade material for preparation of the aerogel may comprise pea protein isolate together with one of: pectin, alginate, locust bean gum or carrageenan; zein; and with one of: beeswax, cottonseed wax, or carnauba wax.

In one embodiment, the food grade material for preparation of the aerogel may comprise potato protein isolate together with pectin. In one embodiment, the food grade material for preparation of the aerogel may comprise potato protein isolate together with alginate. In one embodiment, the food grade material for preparation of the aerogel may comprise potato protein isolate together with carrageenan. In one embodiment, the food grade material for preparation of the aerogel may comprise potato protein isolate together with one of: pectin, alginate, locust bean gum or carrageenan and zein. In one embodiment, the food grade material for preparation of the aerogel may comprise potato protein isolate together with one of: pectin, alginate, locust bean gum or carrageenan; zein; and with one of: beeswax, cottonseed wax, or carnauba wax.

In one embodiment, the food grade material for preparation of the aerogel may comprise stearic acid together with beeswax. In one embodiment, the food grade material for preparation of the aerogel may comprise stearic acid together with cottonseed wax. In one embodiment, the food grade material for preparation of the aerogel may comprise stearic acid together with carnauba wax.

### Preparing the Food Grade Aerogel

Preparation of the aerogel with the selected food grade material is performed using sol-gel chemistry combined with supercritical fluid technology. Gelation refers to the linking of macromolecular chains that progressively leads to larger branched yet soluble polymers, dependent on the starting material structure and conformation. The term “sol” refers to the mixture of the polydisperse soluble branched polymer. As the linking process continues, the size of the branched polymer increases and its solubility decreases. This polymer is permeated with finite branched polymers and is referred to as the “gel.” The transition from a system with finite branched polymer to infinite molecules is referred to as the “sol-gel transition” or “gelation.” Gelation can take place either by physical linking, known as physical gelation, or by chemical linking, known as chemical gelation.

To prepare an aerogel as described herein, a wet gel, or hydrogel, is first formed from the selected food grade material, followed generally by a drying of the hydrogel to form the food grade aerogel. Formation of a hydrogel may involve preparation of an aqueous solution of the selected food grade material and crosslinking hydrophilic polymers. A formed hydrogel should be strong enough that it will not collapse under pressure. Typically, the higher the gelatin bloom number, the better. Gelatin bloom numbers of 200-250 bloom are suitable; however, lower bloom gelatin can be cross-linked to increase the strength if necessary to achieve a suitable hydrogel.

Supercritical drying is then used to form an aerogel, removing the liquid from the gel. This is where the liquid within the gel is removed, leaving only the linked network of the selected food grade material that makes up the aerogel. Supercritical carbon dioxide drying produces higher porosity compared to that obtained from conventional air or vacuum drying methods. This structure promotes rapid water absorption into the aerogel matrix by capillary force.

Following formation of a hydrogel using the selected food grade material, the preparing of the food grade aerogel comprises formation into alcogel using ethanol and drying of the alcogel by supercritical CO₂ technology. More specifically, the preparing of the food grade aerogel through alcogel comprises dehydration of a hydrogel by suspension in a series of ethanol-water solutions of increasing ethanol concentrations. In other words, the formation into an alcogel happens gradually or in stages wherein dehydration of hydrogel to form alcogel comprises suspensions in each of ethanol concentrations of 20%, 40%, 60%, 80% (v/v %)) for at least 15 minutes (each solution), followed by overnight suspension (about 12 hours) in 100% ethanol solution. Progressive suspension periods in increasing ethanol concentration solutions are necessary to replace water gradually and keep the highly porous structure.

Drying of the alcogel by supercritical carbon dioxide generally takes place at a temperature of about 10-50° C. and a pressure of about 500-5,000 psi, with the pressure depending upon the temperature used. In one embodiment, the drying step temperature for preparing the food grade aerogel is about 30° C. to about 40° C. In one embodiment, the drying step for preparing the food grade aerogel is performed at a pressure of between 500 to about 4,000 psi. In one embodiment, the drying step for preparing the food grade aerogel is performed at a pressure of between 1,000 to about 2,500 psi. In one embodiment, the drying step for preparing the food grade aerogel is performed at a pressure of about 1,500 psi. The preparing step may be performed for about 60-300 minutes. In some embodiments, the preparing step under the provided pressure and temperature conditions may take place for about 3-4 hours.

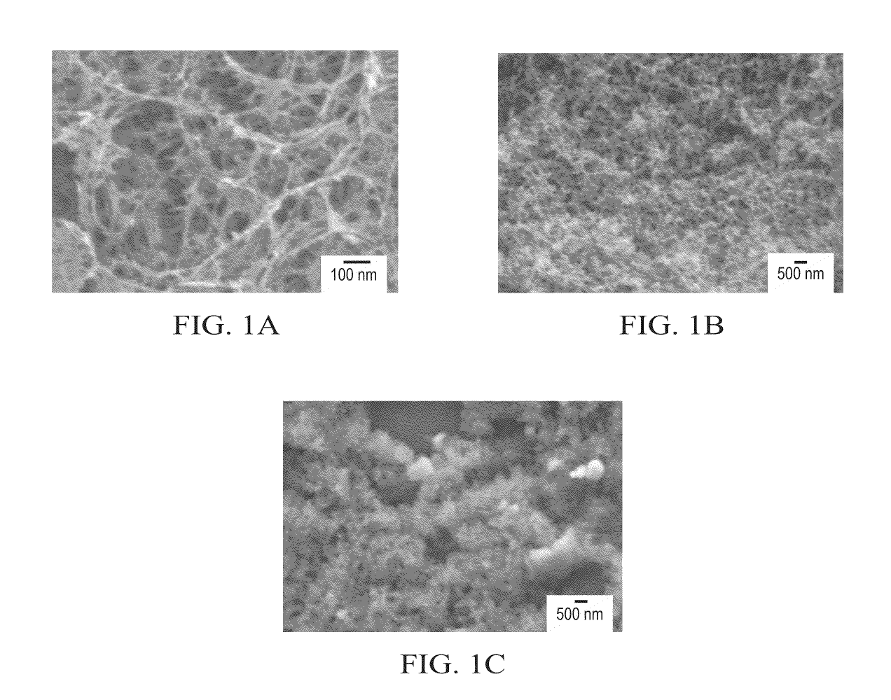

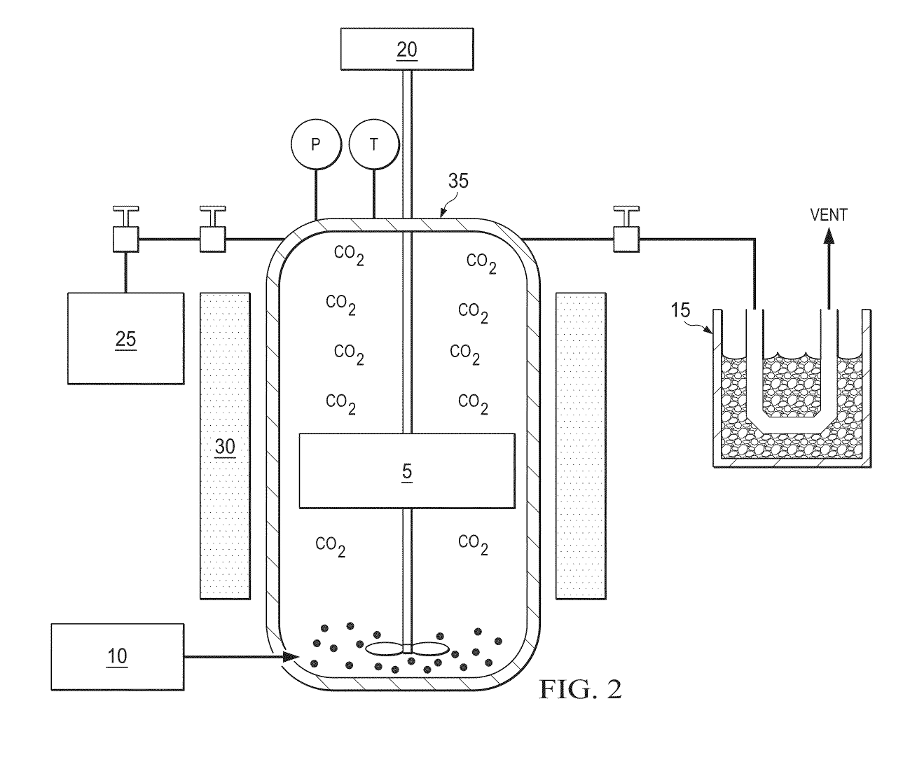

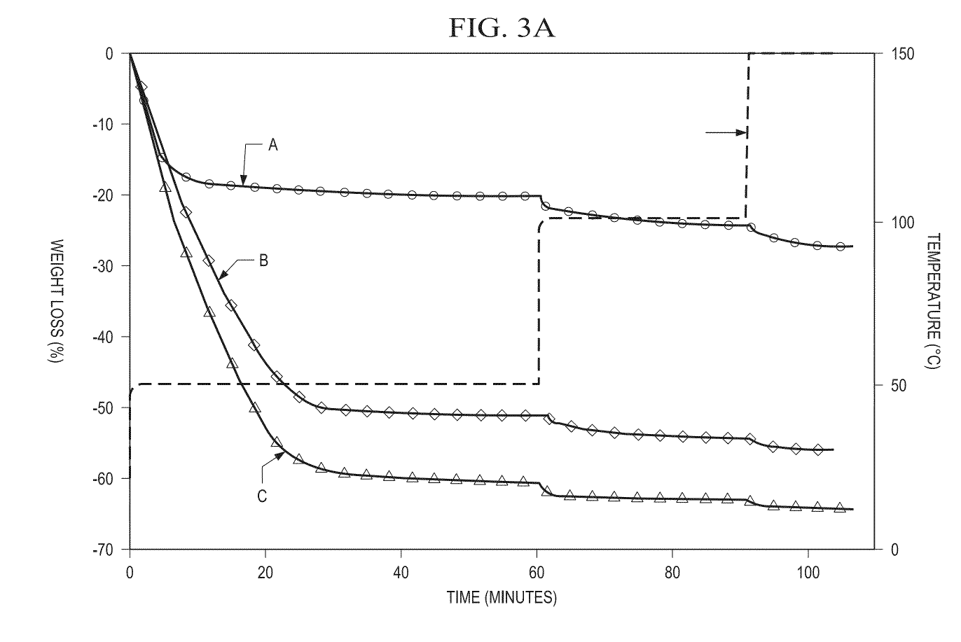

Resulting food grade aerogels are highly porous, with pore sizes ranging from about 1 nm to about 200 nm. In one embodiment, food grade polysaccharide aerogels comprise pore sizes ranging from about 2 to about 100 nm. In one embodiment, food grade aerogels as described herein comprise pore sizes ranging from about 2 to 50 nm. In one embodiment, food grade polysaccharide aerogels comprise a surface area of about 100 to about 700 m²/g. In one embodiment, the food grade polysaccharide aerogel comprises pore volumes of about 0.1 to about 3 cc/g. By way of example, FIGS. 1a-c depicts close up views of prepared alginate, starch, and pectin aerogels, respectively. Table 1, below, provides the typical characteristics determined for these example aerogels.

TABLE 1
Example aerogel typical characteristics

| | Specific surface area | Pore size | Pore volume |
|---|---|---|---|
| Carrier | (m2/g) | (nm) | (cc/g) |
| Alginate aerogel | 500-600 | 2-100 | 1.3 |
| (FIG. 1a) | | | |
| Starch aerogel | 120-250 | 2-100 | 1.0 |
| (FIG. 1b) | | | |
| Pectin aerogel | 200-450 | 2-100 | 0.9 |
| (FIG. 1c) | | | |

Impregnating the Food Grade Aerogel with Flavor

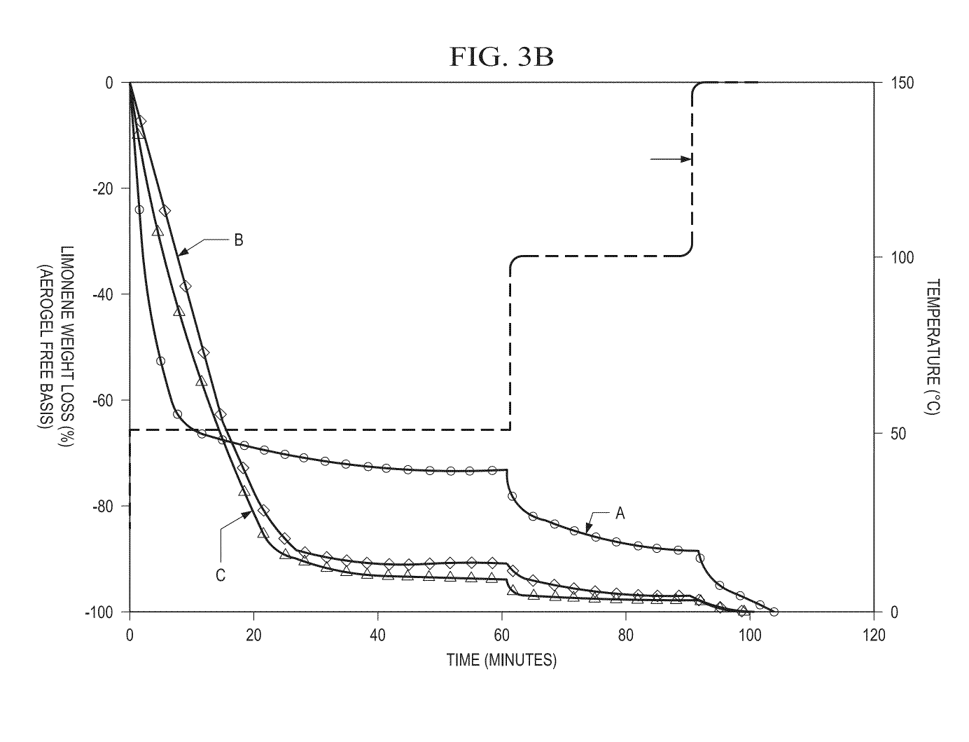

Following formation of a food grade aerogel with a specific food grade material or combination of food grade materials, the method then comprises a second step of using a supercritical carbon dioxide assisted process. As shown in FIG. 2, generally, to fulfill this step a high pressure vessel such as Parr instruments, bench top model 5500 with magnetic stirrer drive 20 into which a flavor 10 is loaded, is used. Any flavor sufficiently soluble in carbon dioxide may be used. Example flavor compounds successfully created using the method described herein include, for example, limonene, citral, ethyl butyrate, and isoamyl acetate, and their combinations. In one embodiment, a flavor 10 is loaded into the high pressure vessel 35. Flavor may be in gas, solid or liquid. In one embodiment, the flavor is in gas form. In one embodiment, the flavor is in solid form. In one embodiment, the flavor is in liquid form. Following loading of a flavor 10, the food grade aerogel 5 is placed in the high pressure vessel and the vessel is then pressurized with carbon dioxide 25 for between about 10 to about 90 minutes, depending on the size of the production scale and/or the strength of the aerogel as well as the nature of the flavor (i.e., the flavor solubility with carbon dioxide). In one embodiment, the vessel is pressured for between 30-60 minutes. The vessel is then slowly depressurized to atmospheric pressure, wherein slowly means a period of time of about 30 to about 60 minutes, or no less than about 30 minutes. The mixing vessel 35 may be heated with the aid of a heater jacket 30 around the vessel for flavor compounds with high vaporization temperatures, followed by use of an ice bath 15 to condense them before venting. It should be noted that the steps for flavor loading mentioned above should be sequential and must occur without any intervening steps.

The resulting impregnated aerogels comprise a flavor loading level of up to about 70% while maintaining 100% of their integrity but in any case, a loading level greater than 20%, which is well above the average loading level of currently available commercial products, which is up to 20%. Regarding the average load currently known, higher loading level may be possible but you would not retain the volatiles as they escape into the vent. In one embodiment, the food grade aerogel flavor encapsulation comprises a flavor loading level of between about 50 to about 60%. During experimental runs, a retention rate of 100% was shown after 2.5 months.

The carbon dioxide assisted flavor impregnation process described herein provides for an oxygen-free closed system under low temperature (i.e., 25 degrees C.). These conditions prevent any (0%) loss off flavor compounds due to oxidation or volatilization. The method described herein therefore significantly improves upon the efficiency of flavor and seasoning delivery in terms of retaining the integrity of flavor compounds and their valuable volatile top notes. This further permits for the use of less flavoring but with a more authentic sensation.

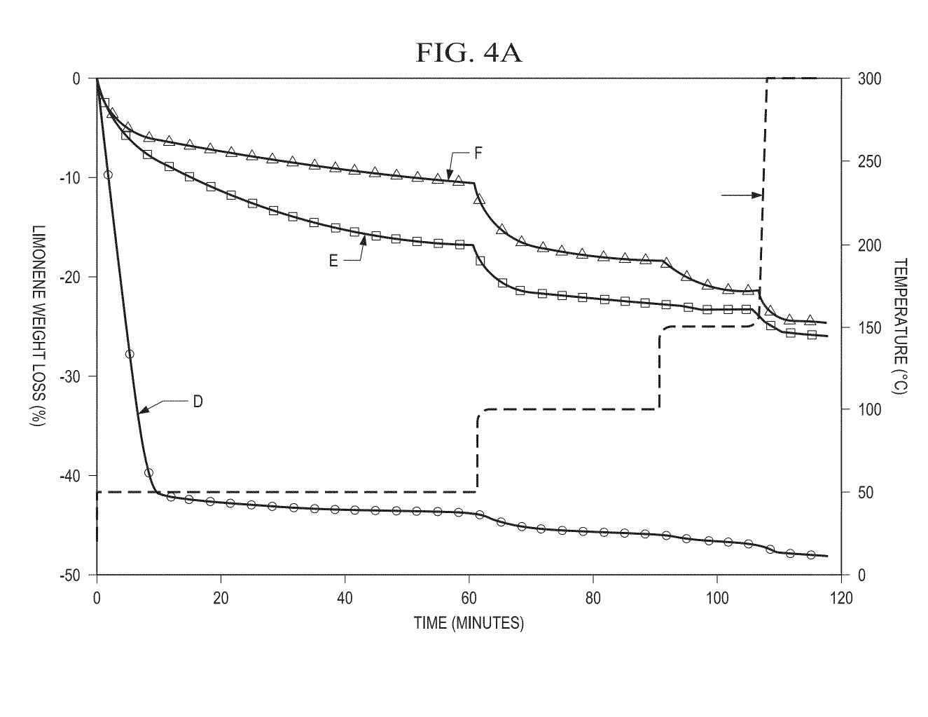

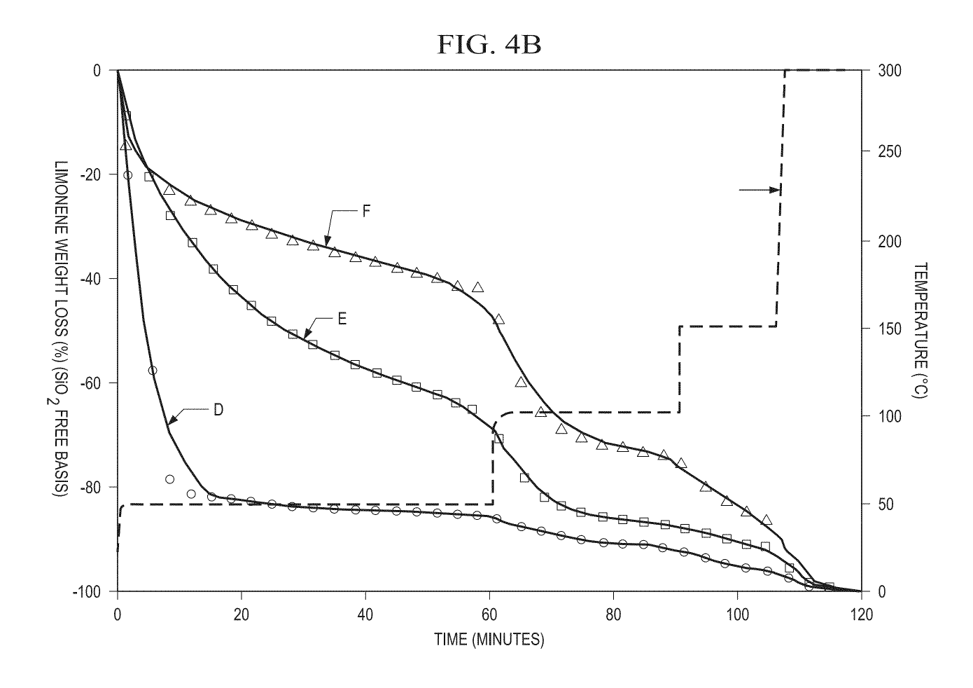

During experimental runs, aerogel-limonene formulations were analyzed by thermogravimetric analysis, depictions of which can be seen in FIGS. 3 and 4. FIGS. 3a and 3b depict analysis of limonene loaded pectin (A), starch (B), and alginate (C) aerogels as described herein. Their initial loading level and loading level after two and half months are shown in Table 2.

TABLE 2

| | | Limonene Loading |
|---|---|---|
| | Initial Limonene | Obtained by TGA after |
| | Loading Obtained | 2.5 months of storage |
| | Gravimetrically | in capped, glass |
| Sample Aerogel | (wt %) | bottles at 22 C. (wt %) |
| Limonene Loaded Pectin (A) | 40 | 25 |
| Limonene Loaded Starch (B) | 55 | 55 |
| Limonene Loaded Alginate | 58 | 63 |
| (C) | | |

By way of comparison, FIGS. 4a and 4b depict analysis of commercially available SiO₂ aerogels loaded with limonene: limonene AEROSIL® 300 (D) (a hydrophilic fumed silica with a specific surface area of 300 m²/g), limonene silica aerogel (E), and limonene silicon dioxide nano particles (F). Table 3, below, depicts the limonene loading possible when using these three commercially available silicon dioxide materials: D-AEROSIL® 300; E—a silica aerogel; and F-silicon dioxide nano particles.

TABLE 3

| | Limonene loading | |
|---|---|---|
| | (wt %) | Limonene loading |
| Example | (gravimetric) | (wt %) (TGA) |
| D | 35 | 45 |
| E | 26 | 26 |
| F | 29 | 25 |

It should be noted that the discrepancy of the first example was caused by a sample spill.

FIGS. 3 and 4 clearly show that the flavor loading level of the three polysaccharide aerogels is much higher than that of the currently available SiO₂ aerogel (E), nanoparticles (F) or aerosol (D).

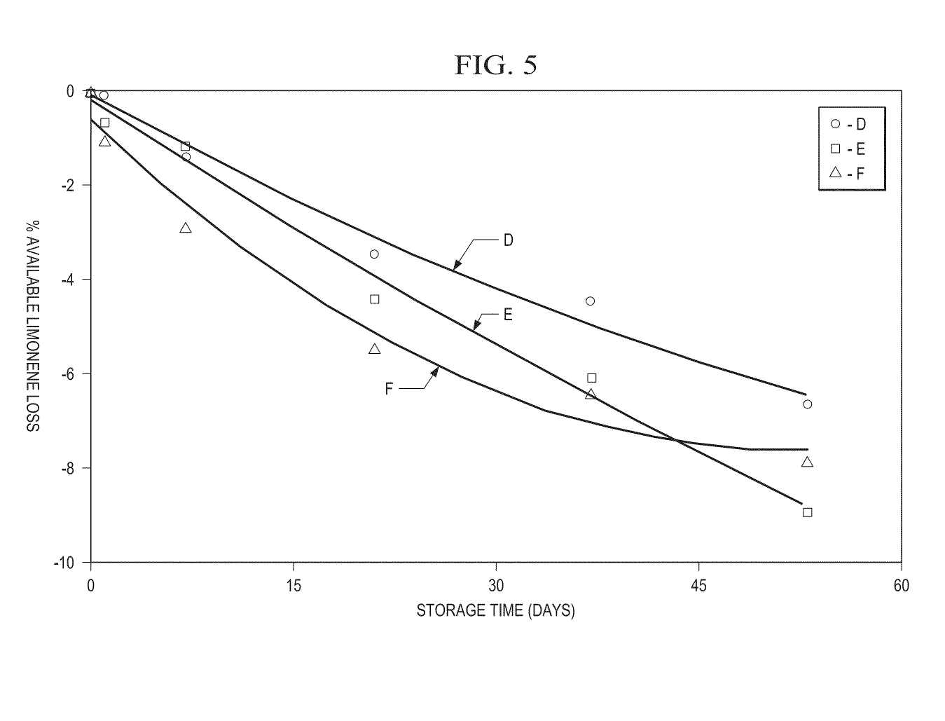

FIG. 5 depicts loaded limonene loss with storage time at room temperature and more specifically, the shelf-life of three limonene loaded silicon dioxide formulations: D-AEROSIL® 300; E—a silica aerogel; and F-silicon dioxide nano particles. Silica aerogel lost 9% of the loaded limonene in 53 days, while there is no limonene loss of the three polysaccharide aerogels after 75 days storage as shown in Table 2.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. It should be understood that where values, including values of ranges, are expressed, another aspect includes the particular or exact values expressed. Thus, if “about 50” is disclosed, then “50” is also disclosed. In the case of ranges, it will be understood that the endpoints of each of the ranges are significant both in relation to the other endpoint, and independently of the other endpoint. A weight percent or percent by weight of a component, unless specifically stated otherwise, is based on the total weight of the formulation or composition in which the component is included.

### EXAMPLES

The following examples are set forth to illustrate the method and results according to the disclosed subject matter. These examples are not intended to be inclusive of all aspects of the subject matter disclosed herein, but rather serve to represent various methods and results. The examples are not meant to exclude equivalents and variants of the method or product that would be apparent to one skilled in the art having read this disclosure.

### Example 1

### Preparation of Whey Protein Isolate Aerogel

Whey protein isolate (WPI) with a protein content of 94% w/w was obtained from Davisco Foods International Inc. (Le Sueur, Minn.) and used to prepare a stock protein solution by dissolving the WPI powder in deionized water. The solution was kept at 4° C. for at least 12 hours to allow for complete dehydration of water. Hydrochloric acid and sodium hydroxide were used to adjust the pH value of the stock protein solution. The protein solutions were poured into sealed steel tubes (d=5 mm, 1=24 mm) and heated to a constant temperature of 80° C. for 30 minutes to induce gelation. During protein gel network formation, van der Waals interactions, hydrogen bonds, electrostatic interactions, hydrophobic interactions and S—S bonds are involved. After cooling to ambient temperature, the hydrogel rods were cut into cylindrical monoliths (d=5 mm, 1=5 mm) using a scalpel. Supercritical impregnation with flavors may then be performed as described above.

### Example 2

### Flavor Loaded Alginate Aerogel

Alginate aerogels were prepared by first preparing hydrogel beads from alginic acid sodium salt. The alginic acid sodium salt was dissolved in distilled water and added drop wise at a rate of 3 mL/min via syringe pump, which was manufactured by KD Scientific, to a stirred MCl₂ solution at 25° C., where M=Ca², Ba², and Zn². Hydrogel beads were formed instantaneously and were then cured in the same solution for 1 hour under mild stirring. To dehydrated the beads to form alcogel beads, the hydrogel beads were suspended in a series of ethanol-water solutions of increasing ethanol concentrations (20, 40, 60, 80 (v/v %)) for 15 minutes in each solution, followed by overnight suspension (about 12 hours) in 100% ethanol solution. The alcogel beads were subsequently dried using supercritical carbon dioxide at 40° C. and 1,400 psi by continuously flowing carbon dioxide through the beads at a rate of 3.5 L (STP)/min for 2 hours. One gram of the obtained alginate aerogel was placed in the middle of a high pressure vessel and limonene flavor oil was placed at the bottom. The vessel was pressurized with carbon dioxide to 1,000 psi. Using an externally mounted heating band, the temperature was maintained about 25° C. Vigorous mixing was performed over the course of 30 to 120 minutes in various test runs under pressurized condition and then slowly depressurized over a period of 30 minutes. Flavor loading amount was determined gravimetrically by aerogel weight gain, which measured weights as 1.58 grams thus, the limonene flavor loading amount could be calculated to be about 58%. To determine shelf life by gravimetric methods, the limonene flavor loaded alginate aerogel were stored at 22° C. in a tightly screwed capped glass bottle. After 2.5 months of storage, the limonene loading obtained gravimetrically was about 63%.

### Example 3

### Flavor Loaded Pectin Aerogel

Five percent (5%) wt/v pectin was added to 0.5M aqueous HCl solution and the mixture was stirred at room temperature (25° C.) until the pectin was fully dissolved (approximately 30 minutes). The solution was then transferred to plastic syringe molds and the formed gel was aged for approximately 24 hours at ambient conditions. Approximately 5 to 6 cm long cylindrical hydrogels were cut into 0.5 to 0.6 cm thick discs with a razor and the discs were suspended in a series of ethanol-water solutions of increasing ethanol concentration (20, 40, 60, 80 v/v %) for 30 minutes in each solution, followed by overnight suspension in 100% ethanol solution. The alcogel discs were subsequently dried using supercritical carbon dioxide at 40° C. and 1,400 psig by continuously flowing carbon dioxide through the discs at a rate of 3.5 L (STP)/min for four hours. Then, the high pressure vessel referenced in Example 1 was used for limonene flavor impregnation. The obtained pectin aerogel was placed in the middle of the vessel and limonene flavor oil was placed at the bottom. The vessel was thereafter pressurized with carbon dioxide to 1,000 psi. Using an externally mounted heating band, the temperature was maintained about 25° C. Vigorous mixing was performed over the course of 30 to 120 minutes in various test runs under pressurized condition and then slowly depressurized over a period of 30 minutes. Limonene flavor loading amount was determined gravimetrically by aerogel weight gain, which measured weights as 1.4 grams; thus, the limonene flavor loading amount could be calculated to be about 40%. To determine shelf life by gravimetric methods, the limonene flavor loaded pectin aerogel were stored at 22° C. in a tightly screwed capped glass bottle. After 2.5 months of storage, the limonene loading obtained gravimetrically was about 25%.

### Example 4

### Flavor Loaded Starch Aerogel

Starch was dispersed in distilled water (10 wt %) and the dispersion was heated to 95° C. with continuous stirring. A translucent solution of starch in distilled water was obtained in approximately 15 minutes. The heating was turned off and the solution was cooled to room temperature by storing at ambient conditions. The solution was then transferred to a plastic syringe and covered with parafilm. The solution gelled in approximately three to five hours. The gels were aged/cured overnight (about 12 hours), by placing in the refrigerator (2-8° C.). Approximately 5 to 6 cm long cylindrical hydrogels were cut into 0.5 to 0.6 cm thick discs with a razor and the discs were suspended in a series of ethanol-water solutions of increasing ethanol concentration (20, 40, 60, 80 v/v %) for 30 minutes in each solution, followed by overnight suspension in 100% ethanol solution. The alcogel discs were subsequently dried using supercritical carbon dioxide at 40° C. and 1,400 psig by continuously flowing carbon dioxide through the discs at a rate of 3.5 L (STP)/min for four hours. Then, the high pressure vessel referenced in Example 1 was used for limonene flavor impregnation. One gram of the obtained starch aerogel was placed in the middle of the vessel and limonene flavor oil was placed at the bottom. The vessel was thereafter pressurized with carbon dioxide to 1,000 psi. Using an externally mounted heating band, the temperature was maintained about 25° C. Vigorous mixing was performed over the course of 30 to 120 minutes in various test runs under pressurized condition and then slowly depressurized over a period of 30 minutes. Limonene flavor loading amount was determined gravimetrically by aerogel weight gain, which measured weights as 1.55 grams; thus, the limonene flavor loading amount could be calculated to be about 55%. To determine shelf life by gravimetric methods, the limonene flavor loaded starch aerogel were stored at 22° C. in a tightly screwed capped glass bottle. After 2.5 months of storage, the limonene loading obtained gravimetrically was determined to be substantially the same at 55%.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. It will be apparent to those of ordinary skill in the art having read this disclosure that various modifications and variations are possible without departing from the spirit or scope of the method and resulting product described herein.

What is claimed is:

1. A non-silica food grade aerogel loaded with a flavor, wherein said aerogel comprises a flavor loading level greater than 20%.

2. The non-silica food grade aerogel of claim 1 wherein the pore sizes range from about 1 to about 200 nm.

3. The non-silica food grade aerogel of claim 1 wherein the flavor loading level is a maximum of about 70%.

4. The non-silica food grade aerogel of claim 1 wherein the aerogel is based on one or more of polysaccharide, protein, and solid lipid.

5. The non-silica food grade aerogel of claim 1 wherein the aerogel is made of: starch, pectin, alginate, cellulose, starch sodium octenyl succinate, locust bean gum, carrageenan, agar, xanthan gum, guar gum, chitosan, gelatin, casein, whey protein isolate, soy protein isolate, pea protein isolate, potato protein isolate, zein, lecithins, stearic acid, beeswax, cottonseed wax, carnauba wax, milk fat, palm and palm kernel oil, or any combination thereof.

6. A method of loading a flavor into an aerogel, said method comprising the steps of:
selecting a food grade material for preparation of a porous food grade aerogel, wherein said food grade material is a non-silica organic material;
preparing the food grade aerogel using a supercritical carbon dioxide assisted process; and
impregnating the food grade aerogel with flavor using a supercritical carbon dioxide assisted process, thereby forming a food grade aerogel loaded with flavor.

7. The method of claim 6 wherein the food grade material is selected from one or more of: polysaccharide, protein, and solid lipid.

8. The method of claim 6 wherein the food grade material is selected from: starch, pectin, alginate, cellulose, starch sodium octenyl succinate, locust bean gum, carrageenan, agar, xanthan gum, guar gum, chitosan, gelatin, casein, whey protein isolate, soy protein isolate, pea protein isolate, potato protein isolate, zein, lecithins, stearic acid, beeswax, cottonseed wax, carnauba wax, milk fat, palm and palm kernel oil, or any combination thereof.

9. The method of claim 6 wherein the preparing step comprises dehydration of a hydrogel by suspension in a series of ethanol-water solutions of increasing ethanol concentrations.

10. The method of claim 6 wherein the preparing step comprises a temperature of about 10-50° C. and a pressure of about 500-5,000 psi.

11. The method of claim 10 wherein the preparing step is performed for about 10-90 minutes.

12. The method of claim 6 wherein the impregnating step comprises the steps of:
loading the flavor into a high pressure vessel;
placing the food grade aerogel in the high pressure vessel;
pressurizing the vessel with carbon dioxide for about 10-90 minutes; and
slowly depressurizing the vessel to atmospheric pressure.

13. The method of claim 6 wherein the food grade aerogel comprises a maximum of about 70% flavor therein.

14. The method of claim 6 wherein the food grade aerogel comprises pore sizes ranging from about 1 nm to about 200 nm.
